(19) United States
(12) Patent Application Publication
(10) Pub. No.: US 2002/0120635 A1
(43) Pub. Date: Aug. 29, 2002

(54) Apparatus and method for providing an electronic book

(76) Inventor: Raymond Anthony Joao, Yonkers, NY (US)

Correspondence Address: RAYMOND A. JOAO, ESQ., 122 BELLEVUE PLACE, YONKERS, NY, 10703, US

(21) Appl. No.: 10/076,537

(22) Filed: Feb. 19, 2002

Related U.S. Application Data
(60) Provisional application No. 60/271,658, filed on Feb. 27, 2001.

(51) Int. Cl. G06F 7/00

(52) U.S. Cl. 707/200

(57) ABSTRACT

An apparatus and method for providing an electronic book, comprising a memory device for storing book information, an input device for inputting information regarding a user request for book information, a processing device for processing the user request for book information, wherein the processing device identifies book information to be provided to the user, and a display device for displaying the book information to the user. The processing device processes a reading termination command and at least one of identifies, records, and stores, a first location, where the presentation of the book information is terminated. A subsequent presentation of the book information to the user commences from a second location located before the first location in the book information and includes a presentation of at least a portion of the book information previously presented to the user.

### RELATED APPLICATIONS

This application claims the benefit of priority of U.S. Provisional Patent Application Ser. No. 60/271,658filed Feb. 27, 2001, and entitled “APPARATUS AND METHOD FOR PROVIDING AN ELECTRONIC BOOK”, the subject matter of which is hereby incorporated by reference herein.

### FIELD OF THE INVENTION

The present invention pertains to an apparatus and a method for providing an electronic book and, in particular, the present invention pertains to an apparatus and method for providing an electronic book which can provide literary content, educational content, instructional content, textbook contents, and/or any other information or content.

### BACKGROUND OF THE INVENTION

Electronic books are electronic devices which can store and/or display literature, content, or materials, which are typically found in printed books. The literature or other content can be provided on a display screen and the individual can thereafter read through the displayed literature or content in much the same way that one may read a printed book page-by-page.

While electronic books can provide many benefits, such as, for example, the benefits derived by storing multiple titles in a single electronic book, the benefits of being able to obtain and/or to download new versions and/or updated versions of literature or content, and/or the benefits derived by the light weight of electronic books as compared to traditional printed books, there are many disadvantages associated with electronic books.

Electronic books do not facilitate the easy flipping back and forth through pages, and/or the ability to view portions of multiple pages at a given instant, which can be easily performed with traditional printed books. Electronic books also fail to provide a means by which to mark a physical paper page or pages which can be easily performed with traditional printed books. Further, electronic books do not facilitate the easy review of literature or content from a previous reading session prior to commencing a new reading session. Many readers typically find that reviewing at least a portion of previously read literature or content, prior to delving into new literature or content, can be beneficial in refreshing the reader's memory.

In spite of the recent developments in electronic books and in electronic book technology, no electronic book or electronic book technology is known or is available which can provide a reader with the opportunity to review at least a portion of literature or content which was read in a previous reading session prior to the reader beginning to read new literature or content in a current or subsequent reading session.

### SUMMARY OF THE INVENTION

The present invention provides an apparatus and a method for providing an electronic book which overcomes the shortfalls of the prior art. The present invention provides an apparatus and method for providing an electronic book which can provide literary content, educational content, instructional content, textbook contents, and/or any other reading information or content.

The present invention can provide literary information, educational information, instructional information, and/or any other information or content which can be provided in, or by, a book. The present invention can also provide any information and/or content which can be provided in, or by, a book in any one or more of paper form, hard copy form, and/or electronic form.

The present invention can provide any one or text information, video information, audio information, multimedia information, and/or any combination of same.

The present invention can also provide a user with a review of information or content which was provided to the user in a previous use of an electronic book or other user device.

The apparatus and method of the present invention can also provide for any one or more of the book-marking of a user's place of location in the information or content, the highlighting of information or content by a user, the generation of notes or outlines relating to, or regarding, the information or content, and/or the sharing of notes or outlines with or between a plurality or group of users.

The present invention can also be utilized in conjunction with a central processing facility which can provide information or content to any of the electronic books or user devices described herein.

The apparatus of the present invention can include any number of electronic book devices. The electronic book device can be any one of more of an electronic book, a user device, a computer, a personal computer, a laptop computer, a kiosk, an electronic kiosk, a personal digital assistant, a telephone, a cellular telephone, a line-connected telephone, a wireless telephone, a digital communication device, a digital telephone, an analog telephone, a video telephone, a videophone, a display telephone, personal communication services (PCS) device, a television, an interactive television, a high definition television, a digital television, a personal communication device, and/or any other suitable device, computer, or communication device.

The apparatus can also include any number of central processing computers for providing information or content, as well as other information, to the electronic book devices. A central processing computer can be associated with any one of more of the publishers, providers, textbook publishers, authors, writers, or distributors, of any of the information or content described herein, and/or any of the books, electronic books, and/or electronic book devices, described herein.

The electronic book device(s) and the central processing computer(s) can transmit signals and/or information to any of the other electronic book device(s) and/or to any of the other central processing computer(s). The electronic book device(s) and the central processing computer(s) can also receive signals and/or information from any of the other electronic book device(s) and/or from any of the other central processing computer(s). The electronic book device(s) and the central processing computer(s) can be linked to each other via a communication network or medium.

The communication network or medium can be any one or more of telecommunication network or system, a telephone communication network or system, a radio communication network or system, a digital communication network or system, a satellite communication network or system, a personal communications services (PCS) network or system, a telecommunication network or system, the Internet, the World Wide Web, a wireless Internet network or system, a wireless World Wide Web network or system, an optical communication network or system, a broadband communication network or system, a Bluetooth communication network or system, a streaming video communication network or system, streaming audio communication network or system, a live video communication network or system, and/or any other suitable communications network or system, and/or any combination(s) thereof.

The electronic book device can include a central processing unit (CPU), a read only memory (ROM) device, a random access memory (RAM) device, a user input device(s), a display device, an output device, a database, a receiver, a transmitter, and a communication device.

The central processing computer can include a central processing unit (CPU), a read only memory (ROM) device, a random access memory (RAM) device, a user input device(s), a display device, an output device, a database, a receiver, a transmitter, and a communication device.

The present invention can be utilized in order to provide an electronic book device which can save a user's place in the respective book's information or content and provide the user with an opportunity to review an amount of information or content review prior to presenting the user with new information or content.

The present invention can be utilized in order to provide the user with reading literature, with textbook reading literature, with educational literature, instructional literature, and/or with any literature, information, and/or content, of any kind or type (hereinafter referred to “book information or content”).

The electronic book device can determine a user's prior stopping location in the respective book information or content, from a previous reading session, and determine a new starting location in the respective book information or content, for a current reading session, which can include a review of a portion of the respective book information or content, previously read by the user. In this manner, the present invention can provide the user with an opportunity to review a portion of the previously read book information or content, prior to reading new book information or content.

The user can read the book information or content at his or her own pace. The book information or content can be text information and can also include links or hyperlinks to audio information, video information, and/or audio and video information, and/or any combination of same. The book information or content can also contain links to additional reading information or materials, supplemental reading information or materials, and/or any other information or materials.

The present invention can be utilized by the user in order to enter notes, highlight reading passages, and/or generate reading notes and/or an outline of the respective portion of the book information or content. The electronic book device can also generate a note file(s) and/or outline file(s) for any notes or outlines created by the user during and/or after a reading session.

The electronic book device can also provide a display of information regarding the location in the book information or content where a previous reading session was terminated and/or from where a current reading session is commencing.

The electronic book device can also receive information or content downloads from the central processing computer at any time, upon user request, and/or automatically. The downloads can contain revised versions of the book information, new editions of the textbook information, and/or announcements from any of the herein-described publishers, providers, textbook publishers, authors, writers, or distributors, of any of the textbook information. The electronic book device can also generate an indication signal, such as a visual indication or an audio indication for providing notification of the download(s) to the user.

The present invention can also be utilized in conjunction with a central processing computer. The user can access the central processing computer, via the electronic book device and request to receive book information or content, request to purchase book information or content, request to receive downloads of any of book information or content, request to receive notification of downloads of book information or content, request information and/or updated information from any of the publishers, providers, textbook publishers, authors, writers, or distributors, of any of the book information or content described herein, post or store notes and/or outlines of the book information or content for later retrieval and/or for retrieval by other users, and/or retrieve notes and/or outlines posted by other users.

The central processing computer can fulfill the user's request by any one or more of providing or transmitting the requested book information or content to the user's electronic book device, processing the user's request to purchase book information or content and/or processing any financial transaction(s) between the user and the respective publisher(s), provider(s), textbook publisher(s), author(s), writer(s), or distributor(s), of the respective book information or content, downloading the requested book information or content to the user's electronic book device, providing the user with notification of any downloads of any of the herein-described book information or content, transmitting to the user any book information and/or updated information from any of the herein-described publishers, providers, textbook publishers, authors, writers, or distributors, storing the user's posting or the storing of notes and/or outlines of book information or content for later retrieval and/or for retrieval by other users, and/or providing and/or transmitting notes and/or outlines posted by other users to the user.

The present invention can also be utilized in conjunction with intelligent agents, software agents, mobile agents, and/or related technologies. The respective intelligent agent (s), software agent (s), mobile agent (s) can be programmed and/or designed to act on behalf of any of the respective users, publishers, providers, textbook publishers, authors, writers, or distributors, of any of the book information or content described herein.

Accordingly, it is an object of the present invention to provide an apparatus and method for providing an electronic book.

It is another object of the present invention to provide an electronic book.

It is still another object of the present invention to provide an apparatus and method for providing an electronic book which can provide any one or more of literary content, educational content, instructional content, textbook content, book information or content and/or any other reading information or content.

It is yet another object of the present invention to provide an electronic book which can provide any book information or content in any one or more of paper form, hard copy form, and/or electronic form.

It is another object of the present invention to provide an electronic book which can provide any one or more of text information, video information, audio information, multimedia information, and/or any combination of same.

It is still another object of the present invention to provide an electronic book which can provide a user with a review of information or content which was provided to the user in a previous reading session.

It is yet another object of the present invention to provide an electronic book which can allow a user to book-mark a location in the information or content.

It is another object of the present invention to provide an electronic book which can allow a user to highlight information or content.

It is still another object of the present invention to provide an electronic book which can allow a user to generate notes or outlines relating to, or regarding, the information or content.

It is yet another object of the present invention to provide an electronic book which can allow users to share notes or outlines relating to, or regarding, the information or content.

It is another object of the present invention to provide an electronic book which can provide information or content to the electronic book from a central processing computer.

It is still another object of the present invention to provide an electronic book which can be any one of more of an electronic book, a user device, a computer, a personal computer, a laptop computer, a kiosk, an electronic kiosk, a personal digital assistant, a telephone, a cellular telephone, a line-connected telephone, a wireless telephone, a digital communication device, a digital telephone, an analog telephone, a video telephone, a videophone, a display telephone, personal communication services (PCS) device, a television, an interactive television, a high definition television, a digital television, a personal communication device, and/or any other suitable device, computer, or communication device.

It is yet another object of the present invention to provide an electronic book which can provide a central processing computer which can be associated with any one of more of the publishers, providers, textbook publishers, authors, writers, or distributors, of any of the information or content.

It is another object of the present invention to provide an electronic book which can be utilized on, over, or in conjunction with, a communication network.

It is still another object of the present invention to provide an electronic book which can be utilized on, over, or in conjunction with, a wireless communication network.

It is yet another object of the present invention to provide an electronic book which can be utilized on, over, or in conjunction with, the Internet or the World Wide Web.

It is another object of the present invention to provide an electronic book which can be utilized on, over, or in conjunction with, the wireless Internet or the wireless World Wide Web.

It is still another object of the present invention to provide an electronic book which can be utilized on, over, or in conjunction with, any one or more of a telecommunication network or system, a telephone communication network or system, a radio communication network or system, a digital communication network or system, a satellite communication network or system, a personal communications services (PCS) network or system, an optical communication network or system, a broadband communication network or system, a Bluetooth communication network or system, a streaming video communication network or system, a streaming audio communication network or system, a live video communication network or system, and/or any other suitable communications network or system, and/or any combination(s) thereof.

It is yet another object of the present invention to provide an electronic book which can save a user's place in the information or content and provide a user with a review of information or content which was provided to the user in a previous reading session.

It is another object of the present invention to provide an electronic book which can provide a user with an opportunity to review an amount of information or content prior to presenting the user with new information or content.

It is still another object of the present invention to provide an electronic book which can determine a user's prior stopping location in book information or content, from a previous reading session, and determine a new starting location in the book information or content, for a current reading session.

It is yet another object of the present invention to provide an electronic book which can provide links or hyperlinks, to any one or more of audio information, video information, or audio and video information, in the information or content.

It is another object of the present invention to provide an electronic book which can provide links or hyperlinks, to additional reading information or materials or supplemental reading information or materials, in the information or content.

It is still another object of the present invention to provide an electronic book which can provide information regarding the location in book information or content where a previous reading session was terminated or from where a current reading session is commencing.

It is yet another object of the present invention to provide an electronic book which can provide downloads from a central processing computer at any time, upon user request, or automatically.

It is another object of the present invention to provide an electronic book which can provide downloads of revised versions of book information or content, or provide new editions of book information or content, to the electronic book.

It is still another object of the present invention to provide an electronic book which can provide, announcements from publishers, providers, textbook publishers, authors, writers, or distributors, of book information or content to the electronic book.

It is yet another object of the present invention to provide an electronic book which can provide notification of a download to the user.

It is another object of the present invention to provide an electronic book which can provide a user with requested book information or content.

It is still another object of the present invention to provide an electronic book which can process a user's request to purchase book information or content.

It is yet another object of the present invention to provide an electronic book which can process a financial transaction involving the purchase of book information or content.

It is another object of the present invention to provide an electronic book which can download book information or content to a user's electronic book.

It is still another object of the present invention to provide an electronic book which can provide a user with notification of a download of book information or content.

It is yet another object of the present invention to provide an electronic book which can transmit book information or updated book information, from publishers, providers, textbook publishers, authors, writers, or distributors, to a user's electronic book.

It is another object of the present invention to provide an electronic book which can store a user's posting or storing of notes or an outline of book information or content for later retrieval.

It is still another object of the present invention to provide an electronic book which can store a user's posting or storing of notes or an outline of book information or content for later retrieval, and/or for retrieval by other users.

It is yet another object of the present invention to provide an electronic book which can provide a user with notes or an outline of book information or content which is posted by other users.

It is another object of the present invention to provide an electronic book which can transmit notes or an outline of book information or content, posted by others, to an electronic book associated with a user.

It is still another object of the present invention to provide an electronic book which can be utilized in conjunction with intelligent agents, software agents, mobile agents, or related technologies.

Other objects and advantages of the present invention will be apparent to those individuals skilled in the art upon a review of the Description Of The Preferred Embodiments taken in conjunction with the Drawings which follow.

### BRIEF DESCRIPTION OF THE DRAWINGS

In the Drawings:

FIG. 1 illustrates a preferred embodiment of the apparatus of the present invention, in flow diagram form;

FIG. 2 illustrates the electronic book device of FIG. 1, in block diagram form;

FIG. 3 illustrates the central processing computer of FIG. 1, in block diagram;

FIGS. 4A and 4B illustrate a preferred embodiment method for utilizing the apparatus of the present invention, in flow diagram form; and

FIG. 5 illustrates a preferred embodiment method for utilizing the apparatus of the present invention, in flow diagram form.

### DESCRIPTION OF THE PREFERRED EMBODIMENTS

The present invention pertains to an apparatus and a method for providing an electronic book and, in particular, the present invention pertains to an apparatus and method for providing an electronic book which can provide literary content, educational content, instructional content, textbook contents, and/or any other reading information or content.

The apparatus and method of the present invention can provide literary information, educational information, instructional information, and/or any other information or content which can be provided in, or by, a book. The apparatus and method of the present invention can also provide any information and/or content which can be provided in, or by, a book in any one or more of paper form, hard copy form, and/or electronic form.

The apparatus and method of the present invention can provide any one or text information, video information, audio information, multimedia information, and/or any combination of same.

The apparatus and method of the present invention can also provide a user with a review of information or content which was provided to the user in a previous use of an electronic book or other user device. In this manner, the apparatus and method of the present invention can provide for a review of information or content previously provided to a user prior to the user being provided with new information or content.

The apparatus and method of the present invention can also provide for any one or more of the book-marking of a user's place of location in the information or content, the highlighting of information or content by a user, the generation of notes or outlines relating to or regarding the information or content, and/or the sharing of notes or outlines with or between a plurality or group of users.

The apparatus and method of the present invention can also be utilized in conjunction with a central processing facility which can provide information or content to any of the electronic books or user devices described herein.

As defined herein, the terms “information” or “content”, or the plurals of same, refer to any information, content, book information or content, literary information, literary content, educational information, educational content, instructional information, instructional content, training information, training content, fictional information, fictional content, non-fictional information, non-fictional content, and/or any other literature, information or content, which can be provided via a book, a conventional print book, and/or an electronic book.

As defined herein, the term “electronic book device” or the plural of same, refers to any electronic book, user device, computer, personal computer, laptop computer, kiosk, electronic kiosk, personal digital assistant, telephone, cellular telephone, wireless telephone, video telephone, videophone, display telephone, television, interactive television, personal communication device, and/or any other device, computer, or communication device, which can be utilized in order to provide a user with any of the information or content described herein.

As utilized herein, the terms “user”, “individual”, or the plural of same, refer to any users or individuals who utilize the electronic book device and/or the apparatus of the present invention.

As utilized herein, the terms “publisher”, “provider”, “textbook publisher”, “distributor”, etc, refer to any publishers, providers, textbook publishers, authors, writers, or distributors, of any of the information or content described herein, and/or of any of the books, electronic books, and/or electronic book devices, described herein.

Applicant hereby incorporates by reference herein the subject matter and teachings of U.S. Provisional Patent Application Serial No. 60/271,658 which teaches and discloses an apparatus and method for providing an electronic book.

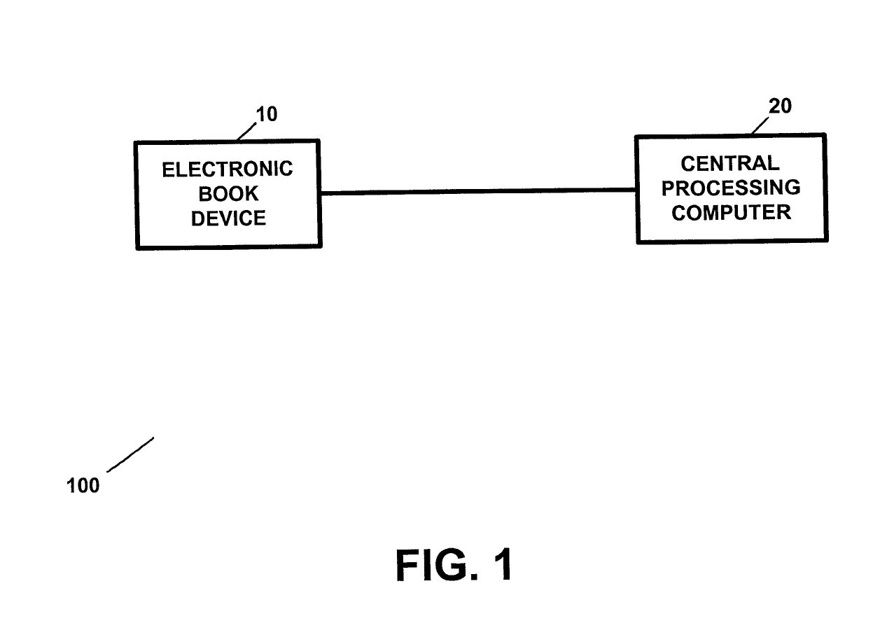

FIG. 1 illustrates the apparatus of the present invention which is designated generally by the reference numeral 100, in block diagram from. With reference to FIG. 1, the apparatus includes an electronic book device 10. The electronic book device 10 can provide any of the respective information or content to a user or individual. The electronic book device 10 can be any one of more of an electronic book, a user device, a computer, a personal computer, a laptop computer, a kiosk, an electronic kiosk, a personal digital assistant, a telephone, a cellular telephone, a line-connected telephone, a wireless telephone, a digital communication device, a digital telephone, an analog telephone, a video telephone, a videophone, a display telephone, personal communication services (PCS) device, a television, an interactive television, a high definition television, a digital television, a personal communication device, and/or any other suitable device, computer, or communication device.

The electronic book device 10 can store and provide any of the information or content which is to be provided to a user of the electronic book device 10.

Any number of electronic book devices 10 can be utilized in conjunction with the apparatus 100.

With reference to FIG. 1, the apparatus 100 can also include a central processing computer 20 which can provide any of the herein-described information or content to any of the electronic book devices 10 which are utilized in conjunction with the apparatus 100. The central processing computer 10 can also perform any of the processing routines and/or functionality described herein as being provided by the central processing computer 20 and/or the apparatus 100.

The central processing computer(s) 20 can be any computer, computer system, network computers system, servers computers, and/or any other computer or system of computers, which can perform the functionality described herein as being provided and/or as being performed by the central processing computer(s) 20. In the preferred embodiment, the central processing computer 20 is a typical central processing and/or server computer such as those utilized in conjunction with an on-line service and/or in network environments as utilized in conjunction with the Internet, the World Wide Web and/or any other suitable network or network environment.

Any number of central processing computer 20 can be utilized in conjunction with the present invention. A central processing computer 20 can be associated with any one of more of the herein-defined publishers, providers, textbook publishers, authors, writers, or distributors, of any of the information or content described herein, and/or any of the books, electronic books, and/or electronic book devices, described herein.

The electronic book device(s) 10 and the central processing computer(s) 20 can transmit signals and/or information to any of the other electronic book device(s) 10 and/or to any of the other central processing computer(s) 20. The electronic book device(s) 10 and the central processing computer(s) 20 can also receive signals and/or information from any of the other electronic book device(s) 10 and/or from any of the other central processing computer(s) 20. The electronic book device(s) 10 and the central processing computer(s) 20 can be linked to each other via a communication network or medium.

In the preferred embodiment, the communication network or medium can be a telecommunication and/or telephone communication network. The telecommunication and/or telephone network may be a line-connected communication network and/or a wireless communication network.

The communication network and/or medium which may be utilized in conjunction with the apparatus and method of the present invention may be any suitable communication system and/or network for transmitting information and/or data, including text, multimedia, video, and/or audio information and/or data or any other suitable information and/or data. In this regard, the communication network and/or medium can be a telecommunication network or system, a telephone network or system, a radio communication network or system, a digital communication network or system, a satellite communication network or system, a personal communications services (PCS) network or system, a telecommunication network or system, the Internet, the World Wide Web, a wireless Internet network or system, a wireless World Wide Web network or system, an optical communication network or system, a broadband communication network or system, a Bluetooth communication network or system, a streaming video communication network or system, a streaming audio communication network or system, a live video communication network or system, and/or any other suitable communications network or system, and/or any combination(s) thereof.

The communications system utilized may operate anywhere in the electromagnetic and/or radio signal frequency spectrum. As noted above, wireless communication networks and associated wireless communications devices, including wireless modems, may be utilized in conjunction with the present invention.

The respective electronic book device(s) 10 and the central processing computer(s) 20, which may be utilized, in the preferred embodiment, can be equipped with the respective and/or corresponding communication equipment for transmitting and/or receiving the signals, data and/or information associated with the utilized communication network, and/or system, and/or any combination(s) thereof.

Applicant hereby incorporates by reference herein the subject matter and teachings of U.S. Pat. application Ser. No. 09/515,060, filed Feb. 28, 2000 and U.S. Pat. application Ser. No. 08/788,387, filed Jan. 27, 1997. Applicant also hereby incorporates by reference herein the teachings of “World Wide Web—Course Tool: An Environment for Building WWW-Based Courses”, Murray W. Goldberg. Fifth International World Wide Web Conference, May 1996; “Virtual MBA”, McCartney, Laton, Informationweek, November 1996; and “Internet, Education, and the Web,” Houstis, et al. Proceedings of WET ICE, 1996.

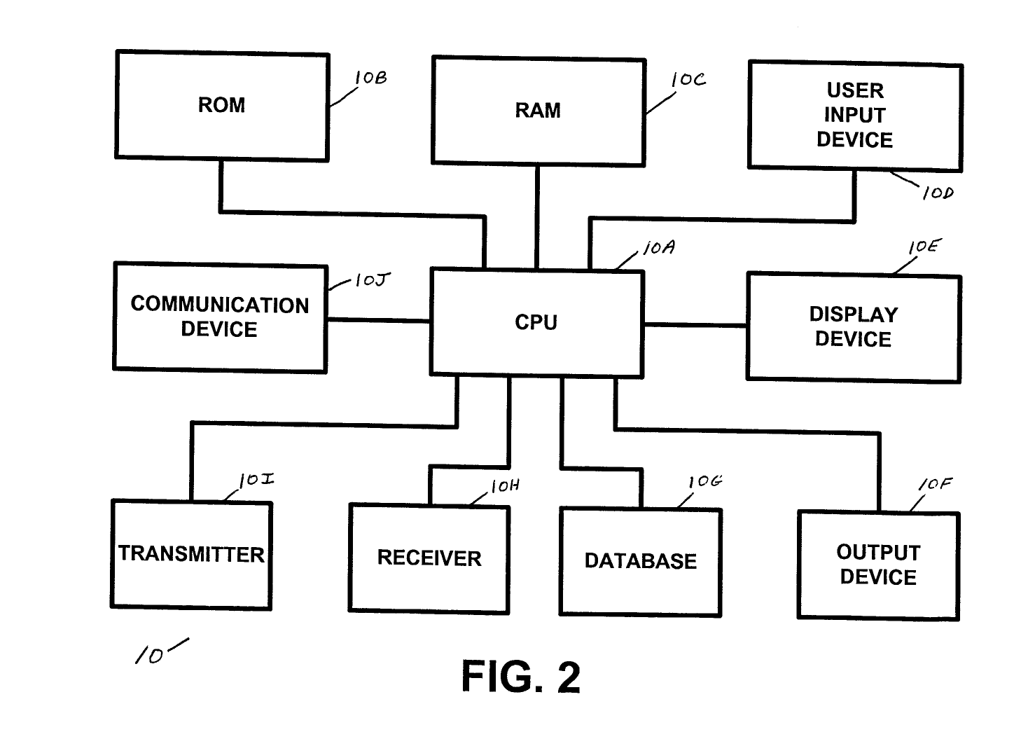

FIG. 2 illustrates the electronic book device 10 of FIG. 1, in block diagram form. With reference to FIG. 2, the electronic book device 10 includes a central processing unit (CPU) 10A. The central processing unit (CPU) 10A may be a microprocessor, a microcomputer, a minicomputer, a macro-computer, or a mainframe computer, depending upon the application.

The electronic book device 10 also includes a read only memory (ROM) device 10B and a random access memory (RAM) device 10C which are also connected to the CPU 10A. The electronic book device 10 also includes a user input device(s) 10D which can include any one or more of a keyboard, a scanner, a user pointing device, such as, for example, a mouse, an audio input device, a touch pad, a video input device, an audio input device, etc., which input device(s) 10D is also connected to the CPU 10A.

The electronic book device 10 also includes a display device 10E, such as a display monitor and/or a display screen for providing the herein-described information or content to the user. The display device 10E can be or a size and shape which is conducive for providing a maximized display area. The display device 10E can also be selected so as to display split screens of pages or text and/or multiple screens of pages or text. The display device 10E is also connected to the CPU 10A. The electronic book device 10 can also include an output device 10F, such as a printer, a display device, and/or a modem, for outputting, in either or both of hard copy form or electronic form, any of the information or content which is described herein as being provided by the electronic book device 10. The output device 10F can also be connected to the CPU 10A.

The electronic book device 10 can also include a database(s) 10G, which can contain and/or store book information or content which can be provided to the user. The book information or content can be the information or content of any book, or any of the books, with which the apparatus 100 can be utilized. The database 10G can also contain information regarding any of the respective publishers, providers, textbook publishers, authors, writers, or distributors, of any of the information or content described herein, and/or of any of the books, electronic books, and/or electronic book devices, described herein. The database 10G can also contain information, links, etc., for enabling the user to link to, and/or to communicate with, any of the herein-described publishers, providers, textbook publishers, or distributors.

The database 10G can also contain any other data and/or information, software programs, and/or software algorithms, for facilitating the processing routines and functionality as described herein as being performed by the electronic book device 10 and/or by the apparatus 100. The database 10G can also be connected to the CPU 10A.

The electronic book device 10 can also include a receiver 10H for receiving data and/or information, including any of the herein-described book information or content, and/or any of the other information described herein as being provided to the electronic book device 10, from any of the central processing computers 20 and/or from any of the other electronic book devices 10 described herein. The receiver 10H can also be connected to the CPU 10A.

The electronic book device 10 can also include a transmitter 10I for transmitting data and/or information, including any of the herein-described book information or content, and/or any of the other information described herein as being provided from the electronic book device 10, to any of the central processing computers 20 and/or to any of the other electronic book devices 10 described herein. The transmitter 10I can also be connected to the CPU 10A.

The electronic book device 10 can also include a communication device 10J which can facilitate user communication with a any of the herein-described publishers, providers, textbook publishers, authors, writers, or distributors, and/or other users of the apparatus 100. For example, the user can communicate with a book publisher or author via the electronic book device. The communication device 10 can be any one or more of a telephone, a video telephone, a videophone, a display telephone, an interactive television, and/or any other communication device for allowing a user to communicate with any of the herein-described publishers, providers, textbook publishers, authors, writers, or distributors, and/or other users of the apparatus 100.

The communication device 10J can provide for live communications, and/or pre-recorded communications (i.e. voice mail, e-mail, etc., beeper message, pager message, etc.). The communication device 10J can include any needed and/or desired microphones, speakers, video recording devices, cameras, and/or video display devices, for facilitating audio, video, and/or audio and video, communications. The communication device 10J can also facilitate telephone or other conferencing and/or video conferencing between the user and/or any of the herein-described publishers, providers, textbook publishers, authors, writers, or distributors, and/or other users of the apparatus 100.

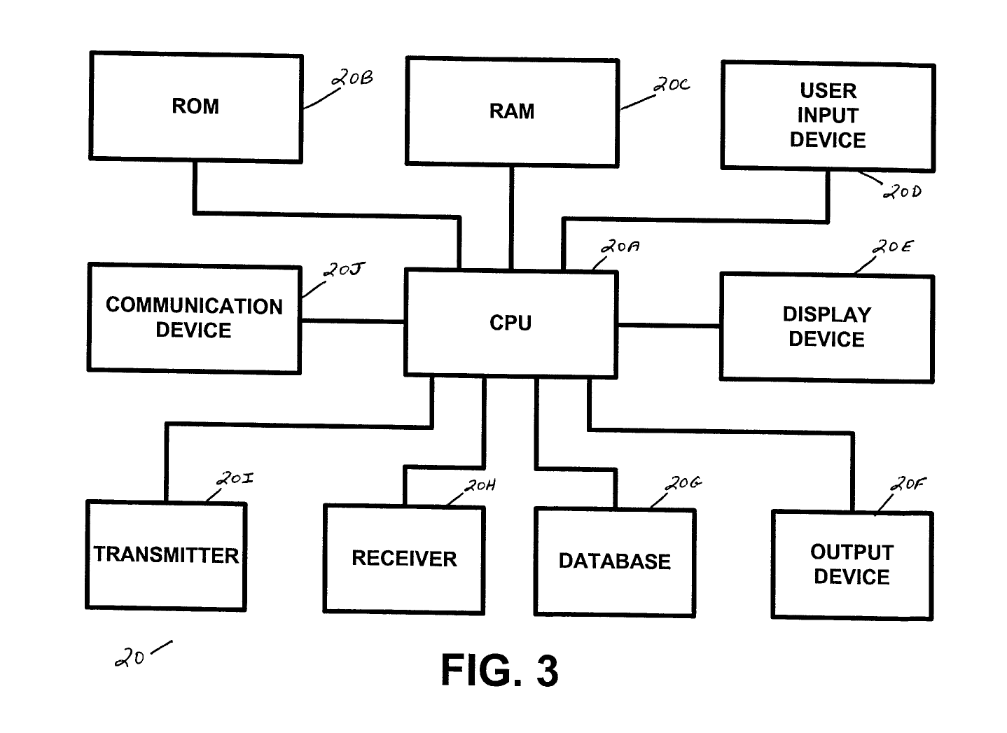

FIG. 3 illustrates the central processing computer 20 of FIG. 1, in block diagram form. With reference to FIG. 3, the central processing computer 20 includes a central processing unit (CPU) 20A. The central processing unit (CPU) 20A may be a microprocessor, a microcomputer, a minicomputer, a macrocomputer, or a mainframe computer, depending upon the application.

The central processing computer 20 also includes a read only memory (ROM) 20B and a random access memory (RAM) 20C which are also connected to the CPU 20A. The central processing computer 20 also includes a user input device(s) 20D which can include any one or more of a keyboard, a scanner, a user pointing device, such as, for example, a mouse, an audio input device, a touch pad, a video input device, an audio input device, etc., which input device(s) 20D is also connected to the CPU 20A.

The central processing computer 20 also includes a display device 20E, such as a display monitor and/or a display screen for providing information to an operator of the central processing computer 20. The display device 20E is also connected to the CPU 20A. The central processing computer 20 can also include an output device 20F, such as a printer, a display device, and/or a modem, for outputting, in either or both of hard copy form or electronic form, any of the information or content which is described herein as being provided by the central processing computer 20. The output device 20F can also be connected to the CPU 20A.

The central processing computer 20 can also include a database(s) 20G, which can contain and/or store book information or content which can be provided to any of the users described herein. The database 20G can also contain information for different editions of any of the herein-described books and/or book information or content. The book information or content can be the information or content of any book, or any of the books, with which the apparatus 100 can be utilized. The book information or content can include text information, video information, audio information, audio and video information, and/or any combination of same.

The database 20G can also contain information regarding any of the respective publishers, providers, textbook publishers, authors, writers, or distributors, of any of the information or content described herein, and/or of any of the books, electronic books, and/or electronic book devices, described herein.

The database 20G can contain the names and/or contact information of or for any of the respective authors, writers, publishers, distributors, of any of the books the information or content of which is provided by the apparatus 100. The database 20G can also contain contact information such as the address, telephone number, facsimile number, e-mail address, IP address, and/or any other contact information, for, or relating to, any of the respective authors, writers, publishers, distributors, who or which provide book information or content and/or for any of the users of the apparatus 100.

The database 20G can also contain account information for any of the users of the apparatus 100. The database 20G can also contain information regarding subscription accounts for providing subscription-based book information or content, or related services, to any of the users of the apparatus 100.

The database 20G can also contain information, links, etc., for enabling the user to link to, and/or to communicate with, any of the herein-described publishers, providers, textbook publishers, authors, writes, or distributors.

The database 20G can also contain information for processing financial transactions between any of the various individuals, entities, or parties, who or which utilize the present invention. For example, book information or content can be purchased on storage media, such as on compact discs, digital video discs, digital virsatile discs, laser discs, floppy discs, and/or can be downloaded on line.

The database 20G can also contain financial account information for any of the various individuals, entities, or parties, who or which utilize the present invention.

The database 20G can also contain any other data and/or information, software programs, and/or software algorithms, for facilitating the processing routines and functionality as described herein as being performed by the central processing computer 20 and/or by the apparatus 100. The database 20G can also be connected to the CPU 20A.

The central processing computer 20 can also include a receiver 20H for receiving data and/or information, including book information or content from other central processing computers 20, described herein as being provided to the central processing computer 20, from any of the other central processing computers 20 and/or from any of the electronic book devices 10 described herein. The receiver 20H can also be connected to the CPU 20A.

The central processing computer 20 can also include a transmitter 20I for transmitting data and/or information, including book information or content to other central processing computers 20 and/or to any of the electronic book devices 10, including any of the herein-described book information or content, and/or any of the other information described herein as being provided from the central processing computer 20, to any of the electronic book devices 10 and/or to any of the other central processing computers 20 described herein. The transmitter 20I can also be connected to the CPU 20A.

The central processing computer 20 can also include a communication device 20J which can facilitate operator communication with a any of the herein-described electronic book device users, publishers, providers, textbook publishers, authors, writers, and/or distributors. For example, the operator can communicate with an electronic book device user, publisher, provider, textbook publisher, author, writer, and/or distributor, via the central processing computer 20. The communication device 20 can be any one or more of a telephone, a video telephone, a videophone, a display telephone, an interactive television, and/or any other communication device for allowing an operator to communicate with any of the herein-described electronic book device users, publishers, providers, textbook publishers, authors, writers, and/or distributors, described herein.

The communication device 20J can provide for live communications, and/or pre-recorded communications (i.e. voice mail, e-mail, etc., beeper message, pager message, etc.). The communication device 20J can include any needed and/or desired microphones, speakers, video recording devices, cameras, and/or video display devices, for facilitating audio, video, and/or audio and video, communications. The communication device 20J can also facilitate telephone or other conferencing and/or video conferencing between the operator and any of the herein-described electronic book device users, publishers, providers, textbook publishers, authors, writers, and/or distributors.

The apparatus 100 of the present invention, in a preferred embodiment, can be utilized in order to provide an electronic book device which can save a user's place in the respective book's information or content and provide the user with an amount of information or content review prior to presenting the user with new information or content. In this regard, the apparatus 100 can be utilized in order to provide the user with an opportunity to refresh his or her memory regarding where, in the information or content, he or she left off in a previous reading session prior to reading new information or content.

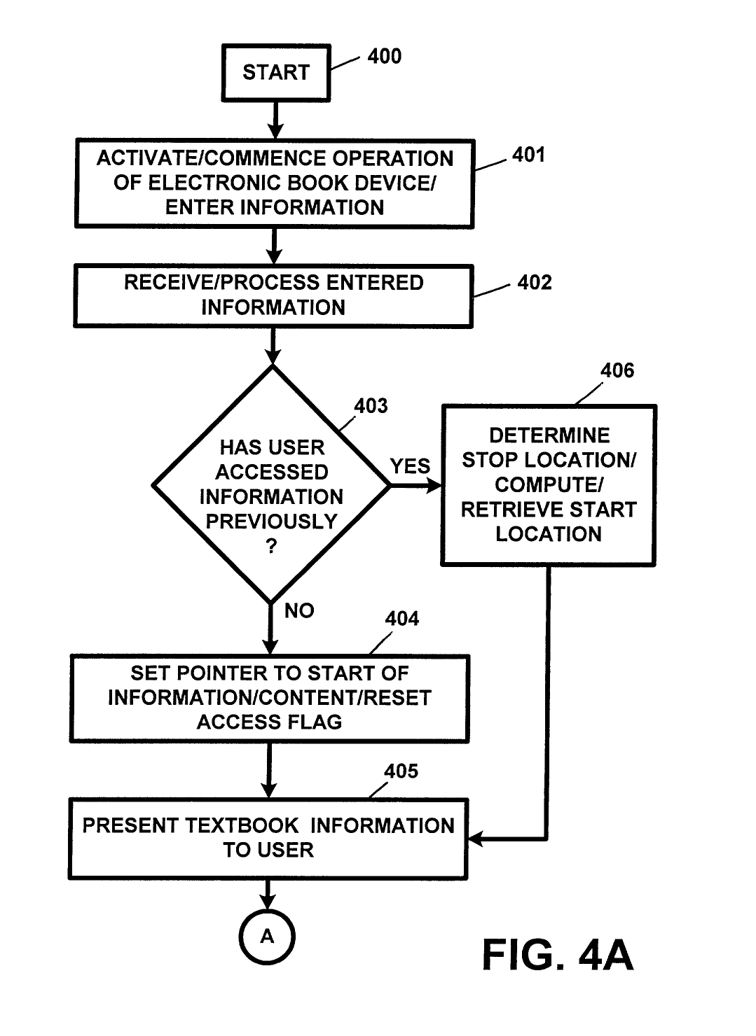

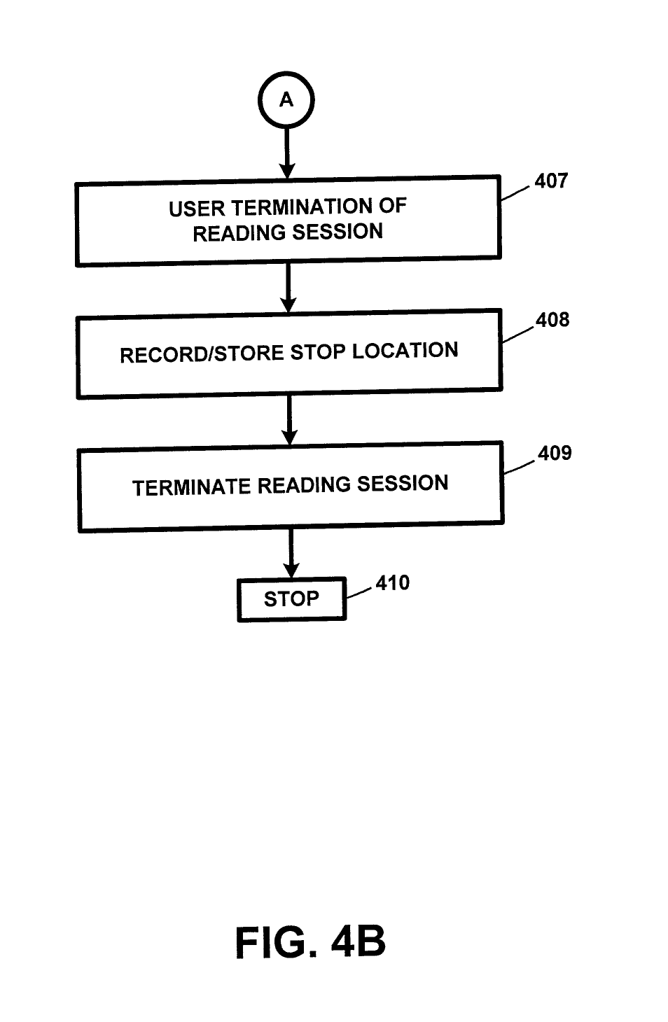

FIGS. 4A and 4B illustrate a preferred embodiment method for utilizing the apparatus and method of the present invention, in flow diagram form. In the embodiment of FIGS. 4A and 4B, the apparatus 100 can provide an electronic book device which can store the location, in the book's information or content, wherein the individual left off in a prior reading session, and provide the individual, in a subsequent reading session, with a review of information or content previously read prior to reading new information or content.

The apparatus of FIGS. 4A and 4B can be utilized in order to provide the user with reading literature, information, or content, of any kind or type, with textbook reading literature, information, or content, of any kind or type, with educational literature, information, or content, or any kind or type, instructional literature, information, or content, or any kind or type, and/or with any literature, information, and/or content, of any kind or type. For purposes of illustration, the embodiment of FIGS. 4A and 4B will described as being utilized in conjunction with an electronic book device 10 which provides textbook information or content, educational information or content, and/or instructional information or content (hereinafter referred to as “textbook information”, “information”, or “reading textbook information”). It is to be understood, however, that the embodiment of FIGS. 4A and 4B can be utilized in conjunction with electronic book devices and/or electronic books which provide any kind or type of reading textbook information, information, or content.

In the embodiment of FIGS. 4A and 4B, the textbook information, or the reading textbook information, can be stored and/or pre-stored in the database 10F of the electronic book device 10F, can be stored or pre-stored on a storage medium, such as a compact disc, a digital video disc, a digital virsatile disc, a laser disc, a floppy disc, a tape, and/or any other storage medium which can be inserted into, and/or loaded into, the electronic book device for playing thereby, and/or can be downloaded from the central processing computer 20, such as in an embodiment, where the central processing computer 20 provides the respective textbook information to the electronic book device as an on-line service.

With reference to FIGS. 4A and 4B, the operation of the apparatus 100 commences at step 400. At step 401, the user can activate and/or commence the operation of the electronic book device 10. At step 401, the user can enter information regarding the textbook information which the user wants to read. It is envisioned that the electronic book device 10 can be utilized to provide the textbook information or reading textbook information for any number of books and/or for any number of courses. In this manner, a student user can utilize the electronic book device 10 of the present invention for his or her reading needs for any number of courses and/or for all of the course for which he or she is enrolled. Similarly, non-student users who may desire to read more than one book at a time, can utilize the electronic book device of the present invention in order to fulfill his or her reading needs.

At step 401, the user can enter information regarding the textbook information which he or she desires to read. At step 402, the CPU 10A will receive and process the user's entered information and access the requested textbook information. Prior to a first accessing of the textbook information by the user, a predetermined data flag, defined as an initial access flag, will be initially set to a pre-defined value which, in the preferred embodiment, is a “1”. Upon the user's first accessing of the textbook information, the CPU 10A will, at step 403, determine if the user has previously accessed the textbook information. To perform this function, the CPU 10A can determine if the initial access flag is set to “1”.

If the user has not previously accessed the textbook information, the CPU 10A will, at step 404, set the material pointer to the start of the textbook information and reset the initial access flag (i.e. reset the flag to “0”). The starting point, location, or position, of the current reading session will then be chosen to be and/or defined to be, the start location or start position of the textbook information and/or the location or position in the textbook information from which the textbook information will be provided or presented to the user.

The operation of the electronic book device 10 will then proceed to step 405 and the textbook information can be presented or provided to the user on the display device 10E. The textbook information, in the preferred embodiment, can be provided to the user page-by-page which the user can read at his or her own pace. The user can advance to the next page by entering a next page command such as, for example, by pressing or depressing an appropriate key. The user can also return to a previous page by entering a previous page command in a similar manner.

In another preferred embodiment, the electronic book device 20 can include voice recognition software and a microphone input device for receiving, processing, and operating, pursuant to a user's verbal or voice commands. In this manner, a user can advance to a next page or return to a previous page by using voice commands.

If, at step 403, it is determined that the user has previously accessed the textbook information, then the CPU 10A will, at step 406, determine and/or retrieve the stop location, or stop position, in the textbook information, where the user's last reading session was terminated or otherwise stopped. This stop location or stop position, in the textbook information, can also be defined to be the point, location, or position, in the textbook information where the user last read and/or last accessed the textbook information and/or the last point, or other defined point in the textbook information where the user has been deemed to have ended or terminated a previous reading session.

The CPU 10A can, at step 406, determine, compute and/or retrieve, the start location or start position in the textbook information from which the current reading session or present reading session may commence. The textbook information, as well as any of the herein-described book information or content, can be encoded and/or marked, digitally and/or otherwise, can be time marked or time-stamped, can be page numbered, can be numbered with video frame reference numbers, and/or can be divided into track segments, and/or can be encoded, marked and/or numbered in a similar manner and/or in an analogous manner as pre-recorded information is marked and/or presented over a computer system and/or stored on compact disks, digital video discs, digital virsatile discs, laser discs, and/or other storage media, so that the respective stop locations or stop positions and/or start locations or start positions can be identified, stored, computed, and/or otherwise processed and/or utilized in the manner described herein.

In this regard, Applicant incorporates by reference herein the teachings of the technologies known in the art in image processing and multimedia, along with digital and time encoding of stored data and/or information, which provides for the means by which to utilize encoding and/or marking to encode or mark reference points, locations and/or positions, in the textbook information which may be utilized in monitoring the dissemination of the textbook information and/or the multimedia and/or other data and/or information described herein. Applicant also incorporates by reference herein the teachings of U.S. Pat. No. 5,969,714 which discloses an interactive video system with frame reference number.

At step 406, the stop location or stop position of the previous reading session can be utilized to compute or determine the start location or start position of the current reading session. A start location or start position of a subsequent reading session can also be determined and/or can be computed from the stop location or stop position. As noted above, the start location or start position can include a certain or pre-specified amount of review or refresher textbook information and/or previously read textbook information so as to provide a review or refresher for the user.

The amount of review or refresher textbook information can be selected by the user, by an administrator, by an instructor of the course to which the textbook information corresponds, by an author, and/or by any other individual or entity, and/or can include any amount of review or refresher textbook information. In another preferred embodiment, the review or refresher textbook information can be defined to be no textbook information thereby resulting in no review or refresher textbook information being presented to the user and the start location or start position of the current reading session, and/or subsequent reading sessions, being defined to be the stop location or stop position of the previous reading session.

As noted above, the start point, start location, or start position, can also be defined to be a point or location in the textbook information (i.e., point, location, position, track, segment, time location, etc. as described herein and/or otherwise) which is located at a point or location, in the textbook information, between the beginning of the textbook information and before, or prior to, the stop point, stop location, or stop position, or marker, at which a prior reading session had been terminated. In this manner, the user can be provided with at least some of the previously read textbook information so as to provide for at least some overlap or continuity, and/or so as to serve as a review or refresher, prior to resuming reading from the location in the textbook information where a previous reading session was terminated.

In a preferred embodiment, the textbook information can be encoded and/or embedded with page number information. For example, page number 1 can be assigned to the first page of a textbook and page number 315 can be assigned to the last page of a 315 page textbook. A user, for example, can read the textbook information up to page number 45 and then terminate the reading session. The stop location or stop position can be recorded and stored to be page number 45.

The CPU 10A can determine and/or compute and store the start location or start position from which the next reading session can begin. This start location or start position can be defined to be 3 pages before the stop location or stop position of the previous reading session so as to provide 3 pages of a review or refresher for the user. In this case, the start location or start position will be determined and/or be computed to be page number 42 and can be stored at the electronic book device 10 or in a memory location therein. When the user seeks to resume reading the textbook information at a current reading session, the CPU 10A will identify page number 45 as the stop location or stop position of the previous reading session and page number 42 as the start location or start position of the current reading session.

The start location or start position, and/or the amount of review and/or refresher textbook information, as noted herein, can be pre-selected and/or can be predefined by electronic book device 10, by the user, by an administrator, by an instructor, by the educational institution, and/or otherwise, and can be changed and/or altered at any time and/or in real-time, by any one or more of the above parties. Thereafter, the textbook information will be presented to or provided to the user from page number 42, thereby providing the user with at least some review or refresher textbook information prior to reading new textbook information from at page 46 and beyond.

The user can also select the amount of any of the above-described review, overlap, and/or review or refresher, textbook information, at any time. The amount of any of the above-described review, overlap, and/or review or refresher, textbook information, can be programmed into the electronic book device 10 by the user at any time, and/or in real-time.

In another preferred embodiment, the textbook information can be encoded with a digital code, and/or otherwise, with the code being correlated with, and/or embedded in, the textbook information, so as to be identified with textbook information, and/or with the various portions, segments, and/or frames or other parts thereof.

In an embodiment where the textbook information is encoded by location or position, such as, for illustrative purposes, with codes or markings respectively, from, for example, 1 at the start of the textbook information to 150 at the end of the textbook information, the following scenario may occur. A user may read the textbook information up to marking 75 and then terminate the session. The stop location or stop position can be recorded and stored to be marking 75.

The central processing computer 10 can determine and/or compute and store the start location or start position from which the next reading session can begin. This start location or start position can be defined to be 5 markings before the stop location or stop position of the previous reading session so as to provide 5 markings worth of a review or refresher for the user. In this case, the start location or start position will be determined and/or be computed to be 70 and can be stored in the electronic book device 10 and/or in an appropriate memory location therein.

When the user seeks to resume reading the textbook information at a current reading session, the CPU 10A will identify marking 75 as the stop location or stop position of the previous reading session and marking 70 as the start location or start position of the current reading session.

The start location or start position, and/or the amount of review and/or refresher textbook information, as noted herein, can be pre-selected and/or can be predefined by electronic book device 10, by the user, by an administrator, by an instructor, by the educational institution, and/or otherwise, and can be changed and/or altered at any time and/or in real-time, by any one or more of the above parties. Thereafter, the textbook information will be presented or provided to the user from marking 70, thereby providing the user with at least some review or refresher textbook information prior to reading new textbook information at marking 76 and beyond.

In an embodiment where the textbook information is encoded by time and/or by time stamping, such as, for illustrative purposes, with codes or markings respectively, representing units of time from, for example, 0 hours, 0 minutes and 0 seconds, at the start of the textbook information to 40 hours, 30 minutes and 15 seconds, at the end of the textbook information, the following scenario may occur. A user may view the textbook information up to time marking 4 hours, 27 minutes, 35 seconds, and then terminate the reading session. The stop location or stop position can be recorded and stored to be time marking 4 hours, 27 minutes, 35 seconds.

The CPU 10A can determine and/or compute and store the start location or start position from which the next reading session can begin. This start location or start position can be defined to be 10 minutes before the stop location or stop position of the previous reading session so as to provide 10 minutes of a review or refresher for the user. In this case, the start location or start position will be determined and/or be computed to be 4 hours, 17 minutes, 35 seconds, and can be stored at the electronic book device 10 and/or at a memory location therein. When the user seeks to resume reading the textbook information at a current reading session, the CPU 10A will identify time marking 4 hours, 27 minutes, 35 seconds as the stop location or stop position of the previous reading session and time marking 4 hours, 17 minutes, 35 seconds, as the start location or start position of the current reading session.

The start location or start position and/or the amount of review and/or refresher textbook information, as noted herein, can be pre-selected and/or can be predefined by electronic book device 10, by the user, by an administrator, by an instructor, by the educational institution, and/or otherwise, and can be changed and/or altered at any time and/or in real-time, by any one or more of the above parties. Thereafter, the textbook information will be presented or provided to the user from time marking 4 hours, 17 minutes, 35 seconds, thereby providing the student with at least some review textbook information or refresher textbook information prior to receiving the last read material at time marking 4 hours, 27 minutes, 35 seconds, and the new textbook information at time marking 4 hours, 27 minutes, 36 seconds and beyond.

Upon determining the start location for the current or present reading session, at step 406, the CPU 10A will then proceed to step 405, and present or provide the textbook information to the user who can read the textbook information.

At step 405, the user can read the textbook information at his or her own pace. The textbook information can be text information and can also include any one or more of video information, audio information, and/or audio and video information. The textbook information can also include links or hyperlinks to audio information, video information, and/or audio and video information, and/or any combination of same. The textbook information can also contain links to additional reading information or materials, supplemental reading information or materials, and/or any other information or materials.

Upon the user's desire to terminate the current reading session, the user can terminate the session, at step 407, by entering a reading session termination command into the electronic book device. Upon reading session termination, the CPU 10A can, at step 408, record and/or store the stop position or stop location (defined herein as the first location or first position) of the textbook information. The stop position or stop location can be stored in the electronic book device 10, and/or in a memory location located therein. At step 408, the CPU 10A can also compute and store the start location or start position in the textbook information (defined as the second location or second position) for the next and/or a subsequent reading session. Upon the storing of the stop location or stop position data, and/or the start location or start position data for the next reading session and/or a subsequent reading session, if so computed or determined, at step 408, the CPU 10A will terminate the reading session, at step 409. Thereafter, the operation of the apparatus 100 will cease at step 410.

The CPU 10A can determine or calculate the start locations or start positions during a current reading session and/or during or upon the termination of a previous reading session.

The electronic book device 10, in the preferred embodiment of FIGS. 4A and 4B, can provide an electronic bookmark in the textbook information. At any time during the reading session, during step 405, and/or at any other time, the user can enter notes, highlight reading passages, and/or generate reading notes and/or an outline of the respective portion of the textbook information. The electronic book device 10 can generate a note file(s) and/or outline file(s) for any notes or outlines created by the user during and/or after a reading session.

The display device 10E of the electronic book device 10 can also, during any reading session, and/or prior to, and/or subsequent to same, provide a display of information regarding the location in the textbook information where a previous reading session was terminated and/or from where a current reading session is commencing. For example, the electronic book device 10 display the page number where a prior reading session was terminated and/or a page number from where a current reading session is commencing.

In another embodiment of FIGS. 4A and 4B, the electronic book device 10 can receive textbook information downloads from the central processing computer 20 at any time, upon user request, and/or automatically. The downloads can contain revised versions of the textbook information, new editions of the textbook information, announcements from any of the herein-described publishers, providers, textbook publishers, authors, writers, or distributors, of any of the textbook information. In instances where the downloads are provided to the electronic book device 10 automatically, the electronic book device 10 can generate a indication signal, such as a visual indication (i.e. light, message on display screen, etc.) or an audio indication (i.e. beeper sound, pager sound, voice-synthesized message, etc.) for providing notification of the download to the user.

The electronic book device 10E, in any and/or all of the embodiments described herein, can display multiple pages of text to the user at the same time. This can be accomplished by the electronic book device 10E displaying multiple pages of text in either a split screen format and/or a multiple screen format.

As noted above, the preferred embodiment of FIGS. 4A and 4B can be utilized in a same, a similar, and/or an analogous manner, in order to present or provide literary information or content of any type or kind, educational information or content of any type or kind, instructional information or content of any type or kind, and/or reading information or content of any type or kind.

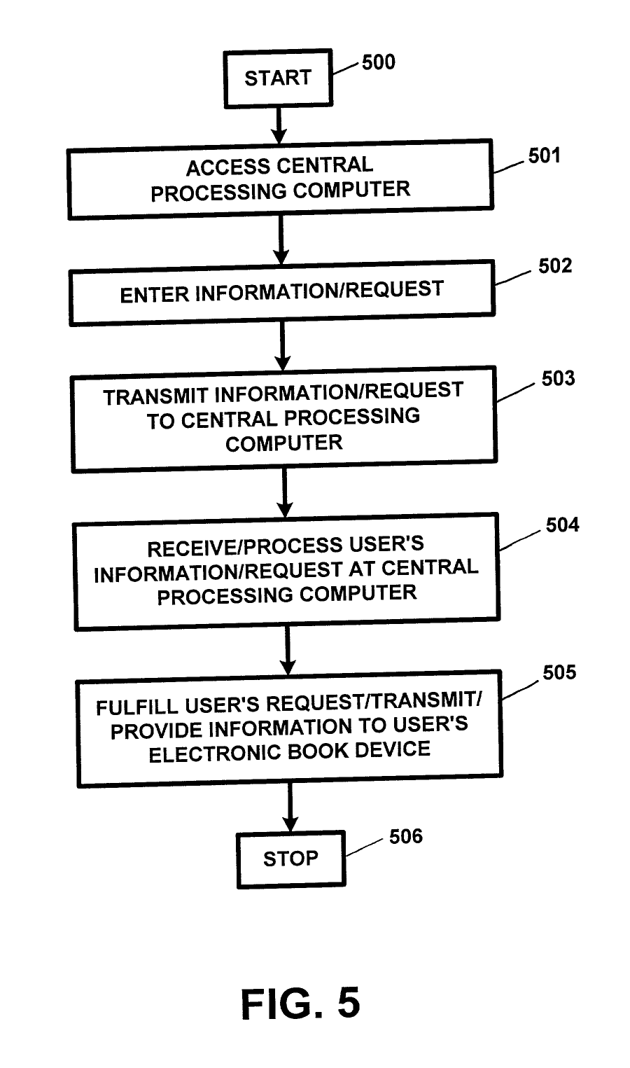

In another preferred embodiment, the electronic book device 10 can be utilized in conjunction with the central processing computer 20. FIG. 5 illustrates another preferred embodiment method for utilizing the apparatus 100 of the present invention, in flow diagram form. With reference to FIG. 5, the operation of the apparatus 100 commences at step 500. At step 501, the user can access the central processing computer 20 via the electronic book device 10.

At step 502, the user can enter information regarding a request for any number of services which can be provided to the user by the central processing computer 20. At step 502, the user can enter information regarding any one or more of request to receive any of the herein-described book information or content, request to purchase book information or content, request to receive downloads of any of the herein-described book information or content, request to receive notification of downloads of any of the herein-described book information or content, request information and/or updated information from any of the herein-described publishers, providers, textbook publishers, authors, writers, or distributors, of any of the book information or content described herein, post or store notes and/or outlines of the book information or content for later retrieval and/or for retrieval by other users, and/or retrieve notes and/or outlines posted by other users.

At step 503, the user request information can be transmitted to the central processing computer 20. At step 504, the user request information can be received and processed by central processing computer 20. At step 504, the central processing computer can also any one or more of respectively process the user's request to receive any of the herein-described book information or content, process the user's request to purchase book information or content, process the user's request to receive downloads of any of the herein-described book information or content, process the user's request to receive notification of downloads of any of the herein-described book information or content, process the user's request for information and/or updated information from any of the herein-described publishers, providers, textbook publishers, authors, writers, or distributors, of any of the book information or content described herein, process the user's posting or the storing of notes and/or outlines of book information or content for later retrieval and/or for retrieval by other users, and/or process the user's request for retrieving notes and/or outlines posted by other users.

At step 505, the central processing computer 20 can fulfill the user's request by any one or more of providing or transmitting the requested book information or content to the user's electronic book device 10, processing the user's request to purchase book information or content and/or processing any financial transaction(s) between the user and the respective publisher(s), provider(s), textbook publisher(s), author(s), writer(s), or distributor(s), of the respective book information or content, downloading the requested book information or content to the user's electronic book device 10, providing the user with notification of any downloads of any of the herein-described book information or content, by any one or more of generating and transmitting a e-mail message, instant messaging service message, a facsimile message, a telephone message, a beeper message, a pager message, and/or any other electronic transmission to the user or to the user's electronic book device 10, transmitting to the user any information and/or updated information from any of the herein-described publishers, providers, textbook publishers, authors, writers, or distributors, by any one or more of generating and transmitting a e-mail message, instant messaging service message, a facsimile message, a telephone message, a beeper message, a pager message, and/or any other electronic transmission to the user or to the user's electronic book device 10, storing the user's posting or the storing of notes and/or outlines of book information or content for later retrieval and/or for retrieval by other users, and/or providing and/or transmitting notes and/or outlines posted by other users to the user by any one or more of generating and transmitting a e-mail message, instant messaging service message, a facsimile message, a telephone message, a beeper message, a pager message, and/or any other electronic transmission to the user or to the user's electronic book device 10.

The operation of the apparatus 100 will, thereafter, cease, at step 506.

In another preferred embodiment, as well as in any of the embodiments described herein, intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of any of the respective users, publishers, providers, textbook publishers, authors, writers, or distributors, of any of the book information or content described herein.

The intelligent agent can act on behalf of any of the respective users, publishers, providers, textbook publishers, authors, writers, or distributors, of any of the book information or content described herein. The intelligent agent can any one or more of provide notification to an operator of the central processing computer 20 and/or to any of the herein-described publishers, providers, textbook publishers, authors, writers, or distributors, of a user's request to receive any of the herein-described book information or content, provide notification to an operator of the central processing computer 20 and/or to any of the herein-described publishers, providers, textbook publishers, authors, writers, or distributors, of a user's request to purchase book information or content, provide notification to an operator of the central processing computer 20 and/or to any of the herein-described publishers, providers, textbook publishers, authors, writers, or distributors, of a user's request to receive downloads of any of the herein-described book information or content, provide notification to a user of a download(s) of any of the herein-described book information or content, provide notification to an operator of the central processing computer 20 and/or to any of the herein-described publishers, providers, textbook publishers, authors, writers, or distributors, of a user's request to receive information and/or updated information from any of the herein-described publishers, providers, textbook publishers, authors, writers, or distributors, provide notification to a user or users of another user's posting or storing of notes and/or outlines of reading materials, and/or provide notification to a user of the availability and/or posting of notes and/or outlines which have been posted by other users.

Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

Applicant hereby incorporates by reference herein the subject matter and teachings of the following U.S. Patents:

U.S. Pat. No. 6,167,409 Computer system and method for customizing context information sent with document fragments across a computer network

U.S. Pat. No. 6,157,392 Animation packager for an on-line book

U.S. Pat. No. 6,144,380 Method of entering and using handwriting to identify locations within an electronic book

U.S. Pat. No. 6,124,851 Electronic book with multiple page displays

U.S. Pat. No. 6,064,766 Handwritten keyboardless entry computer system

U.S. Pat. No. 6,055,544 Generation of chunks of a long document for an electronic book system

U.S. Pat. No. 6,052,117 Information display system for electronically reading a book

U.S. Pat. No. 6,041,215 Method for making an electronic book for producing audible sounds in response to visual indicia

U.S. Pat. No. 6,037,954 Portable hand-held reading device

U.S. Pat. No. 6,021,306 Apparatus for presenting visual material with identified sensory material

U.S. Pat. No. 6,002,799 Handwritten keyboardless entry computer system

U.S. Pat. No. 5,991,780 Computer based system, method, and computer program product for selectively displaying patent text and images

U.S. Pat. No. 5,991,594 Electronic book

U.S. Pat. No. 5,986,690 Electronic book selection and delivery system

U.S. Pat. No. 5,957,697 Printed book augmented with an electronic virtual book and associated electronic data

U.S. Pat. No. 5,956,048 Electronic book system

U.S. Pat. No. 5,956,034 Method and apparatus for viewing electronic reading materials

U.S. Pat. No. 5,933,526 Handwritten keyboardless entry computer system

U.S. Pat. No. 5,909,690 Apparatus and method for page-retrieval using electronic book display

U.S. Pat. No. 5,907,845 Method and system for organizing on-line books using bookcases

U.S. Pat. No. 5,897,324 Multimedia-book operable with removable data storage media implemented with universal interfacing book-adapting processor

U.S. Pat. No. 5,893,132 Method and system for encoding a book for reading using an electronic book

U.S. Pat. No. 5,893,109 Generation of chunks of a long document for an electronic book system

U.S. Pat. No. 5,850,520 Method and system for electronic publication distribution including return receipt

U.S. Pat. No. 5,847,698 Electronic book device

U.S. Pat. No. 5,810,604 Electronic book and method

U.S. Pat. No. 5,802,516 Method of controlling an electronic book for a computer system

U.S. Pat. No. 5,790,176 Media server for supplying video and multi-media data over the public switched telephone network

U.S. Pat. No. 5,774,109 Electronic scrolling book with temporary interruptions

U.S. Pat. No. 5,761,682 Electronic book and method of capturing and storing a quote therein

U.S. Pat. No. 5,761,485 Personal electronic book system

U.S. Pat. No. 5,717,938 Coded cartridges for electronic books

U.S. Pat. No. 5,697.793 Electronic book and method of displaying at least one reading metric therefor

U.S. Pat. No. 5,663,748 Electronic book having highlighting feature

U.S. Pat. No. 5,640,552 Method and apparatus for providing multi-level searching in an electronic book

U.S. Pat. No. 5,586,235 Interactive multimedia system and method

U.S. Pat. No. 5,534,888 Electronic book

U.S. Pat. No. 5,524,201 Method of Preparing an electronic book for a computer system

U.S. Pat. No. 5,475,399 Portable hand held reading unit with reading aid feature

U.S. Pat. No. 5,417,575 Electronic book

U.S. Pat. No. 5,392,387 Method and system for enhanced data access efficiency in an electronic book

U.S. Pat. No. 5,365,598 Handwritten keyboardless entry computer system

U.S. Pat. No. 5,239,665 Electronic book having several keys for changing pages and underlining certain portions of text

U.S. Pat. No. 5,167,508 Electronic book

U.S. Pat. No. 5,157,737 Handwritten keyboardless entry computer system

U.S. Pat. No. 5,146,552 Method for associating annotation with electronically published material

U.S. Pat. No. 4,985,697 Electronic book educational publishing method using buried reference materials and alternate learning levels

U.S. Pat. No. 4,855,725 Microprocessor based simulated book

U.S. Pat. No. 4,820,167 Electronic school teaching system

U.S. Pat. No. 4,159,417 Electronic book

While the present invention has been described and illustrated in various preferred embodiments, such descriptions are merely illustrative of the present invention and are not to be construed to be limitations thereof. In this regard, the present invention encompasses all modifications, variations and/or alternate embodiments with the scope of the present invention being limited only by the claims which follow.

What is claimed is:

1. An apparatus for providing an electronic book, comprising:
a memory device for storing book information;
an input device for inputting information regarding a user request for book information;
a processing device for processing the user request for book information, wherein the processing device identifies book information to be provided to the user; and
a display device for displaying the book information to the user,
wherein the processing device processes a reading termination command entered by the user via the input device, and further wherein the processing device terminates the presentation of the book information, and further wherein the processing device at least one of identifies, records, and stores, a first location, wherein the first location is the location in the book information where the presentation of the book information is terminated, and further wherein a subsequent presentation of the book information to the user commences from a second location which is located before the first location in the book information, and further wherein the subsequent presentation of the book information includes a presentation of at least a portion of the book information previously presented to the user.

2. The apparatus of claim 1, wherein the book information is at least one of page marked, encoded, marked, digitally encoded, analog encoded, digitally marked, analog marked, time-marked, time-stamped, and frame numbered, and further wherein the processing device processes the first location in conjunction with an amount of book information to be reviewed in order to generate the second location.

3. The apparatus of claim 1, wherein the apparatus is at least one of an electronic book, a user device, a computer, a personal computer, a laptop computer, a kiosk, an electronic kiosk, a personal digital assistant, a telephone, a cellular telephone, a line-connected telephone, a wireless telephone, a digital communication device, a digital telephone, an analog telephone, a video telephone, a videophone, a display telephone, personal communication services (PCS) device, a television, an interactive television, a high definition television, a digital television, and a personal communication device.

4. The apparatus of claim 1, wherein the book information includes at least one of text information, audio information, video information, audio and video information, and a link to at least one of text information, audio information, video information, audio and video information.

5. The apparatus of claim 1, wherein the book information is at least one of literature, textbook information, educational information, instructional information, reading material, newspaper materials, and magazine materials.

6. The apparatus of claim 1, further comprising:
a receiver for receiving book information which is at least one of transmitted from and downloaded from a central processing computer.

7. The apparatus of claim 1, further comprising:
a transmitter for transmitting a request for book information to a central processing computer.

8. The apparatus of claim 1, further comprising:
a communication device for facilitating communication between the user and a third party at least one of associated with a central processing computer and associated with another apparatus.

9. The apparatus of claim 8, wherein the third party is at least one of a publisher, a provider, a textbook publisher, an author, a writer, of the book information.

10. The apparatus of claim 1, wherein the processing device determines whether the user is reading the book information for a first time.

11. A method for providing an electronic book, comprising:
storing book information;
inputting information regarding a user request for book information;
processing the user request for book information;
identifying book information to be provided to the user;
displaying the book information to the user;
processing a reading termination command entered by the user;
terminating the presentation of the book information; and
at least one of identifying, recording, and storing, a first location, wherein the first location is the location in the book information where the presentation of the book information is terminated, and further wherein a subsequent presentation of the book information to the user commences from a second location which is located before the first location in the book information, and further wherein the subsequent presentation of the book information includes a presentation of at least a portion of the book information previously presented to the user.

12. The method of claim 11, wherein the book information is at least one of page marked, encoded, marked, digitally encoded, analog encoded, digitally marked, analog marked, time-marked, time-stamped, and frame numbered, and wherein the method further comprises:
processing the first location in conjunction with an amount of book information to be reviewed in order to generate the second location.

13. The method of claim 11, wherein the method is utilized in conjunction with at least one of an electronic book, a user device, a computer, a personal computer, a laptop computer, a kiosk, an electronic kiosk, a personal digital assistant, a telephone, a cellular telephone, a line-connected telephone, a wireless telephone, a digital communication device, a digital telephone, an analog telephone, a video telephone, a videophone, a display telephone, personal communication services (PCS) device, a television, an interactive television, a high definition television, a digital television, and a personal communication device.

14. The method of claim 11, wherein the book information includes at least one of text information, audio information, video information, audio and video information, and a link to at least one of text information, audio information, video information, audio and video information.

15. The method of claim 11, wherein the book information is at least one of literature, textbook information, educational information, instructional information, reading material, newspaper materials, and magazine materials.

16. The method of claim 11, further comprising:
receiving book information which is at least one of transmitted from and downloaded from a central processing computer.

17. The method of claim 11, further comprising:
transmitting a request for book information to a central processing computer.

18. The method of claim 11, further comprising:
facilitating communication between the user and a third party at least one of associated with a central processing computer and associated with another apparatus, wherein the third party is at least one of a publisher, a provider, a textbook publisher, an author, a writer, of the book information.

19. The method of claim 11, further comprising:
determining whether the user is reading the book information for a first time.

20. An apparatus for providing an electronic book, comprising:
a receiver for receiving a user request for at least one of book information, a download of book information, a book information update, information at least one of from and regarding at least one of a publisher, provider, distributor, author, and writer, of book information, a request to post notes regarding book information, and a request to retrieve notes regarding book information posted by another user;
a processor for processing the user request; and
a transmitter for transmitting information responsive to the user request to an electronic book associated with the user;
wherein the apparatus provides at least one of the transmits the requested at least one of book information, a download of book information, a book information update, information at least one of from and regarding at least one of a publisher, provider, distributor, author, and writer, of book information, and notes regarding book information posted by another user, and stores notes regarding book information posted by the user.
